(19) United States
(12) Patent Application Publication
(10) Pub. No.: US 2003/0158919 A1
(43) Pub. Date: Aug. 21, 2003

(54) Method for deploying version control system server software having remote access capability

(75) Inventor: Anatoli Fomenko, San Jose, CA (US)

Correspondence Address: David B. Ritchie, Thelen Reid & Priest LLP, P.O. Box 640640, San Jose, CA, 95164, US

(73) Assignee: Sun Microsystems, Inc., a Delaware Corporation

(21) Appl. No.: 10/082,038

(22) Filed: Feb. 20, 2002

(51) Int. Cl. G06F 15/177

(52) U.S. Cl. 709/220

(57) ABSTRACT

In a software development environment, a method for deploying version control system server software having a remote access capability, includes (a) providing a functional software unit implementing version control system server functionality, (b) providing a deployment descriptor for directing a deployment tool to deploy the module, (c) packaging the functional software unit with the deployment descriptor into a Web module for deployment, and (d) deploying the Web module onto a Web server platform using the deployment tool of the software development environment. The deployment tool includes a server plug-in provided by a provider of the hosting server software of the Web server platform. The server plug-in automatically installs a Web module on a corresponding server platform when the Web module complies with the component-based platform-independent specification. The version control system server software may also be packaged into an application-level software package that can be deployed to an application server.

### FIELD OF THE INVENTION

The present invention relates to a software development environment. More particularly, the present invention relates to deployment of a version control system server in a software development environment complying with a component-based platform-independent specification.

### BACKGROUND OF THE INVENTION

As new technologies such as client/server architecture, object-oriented programming, multi-platform deployment, and multi-language interoperability grow, software development projects become larger and more complex. Software developers work in groups rather than individually. They share information, data and responsibilities, and various phases and levels of the software development evolve concurrently, i.e., in parallel. In such a team/parallel development process, there is a greater possibility of duplicated effort, conflict between changes made by different developers, lost changes, and the like. As a result, most software development teams use a software configuration management (or source code management (SCM)) system. An SCM system keeps track of large software development projects, and typically includes a version control system, which maintains a database or a file system for revisions of the software under development. It is able to recreate each build of the software as well as to recreate earlier environments in order to assist in the maintenance of previous versions of a software product. It may also be used to prevent unauthorized access to files or to alert the appropriate users when a file has been altered. For example, Forte™ TeamWare, available from Sun Microsystems, Inc. of Palo Alto, Calif., provides software configuration management, version control, change control, build management, integration, system administration, and the like.

The version control system of TeamWare employs a Copy-Modify-Merge model. The data with which a software development team works is organized into files (“documents”) and directories (“folders”). The files are placed in a special directory called a workspace. A workspace is a specially designated directory and its subdirectories. The workspace is called the “parent,” and holds the master copy of all files (“master files”). Individual team members create their own workspace (“child” workspace) by copying the parent workspace (“bringover”). A child workspace is an exact copy of the current master files in the parent workspace, and inherits all characteristics of the parent workspace. The individual team members work on their own copies of the files in the child workspace, and update them. Updating includes addition, deletion, and renaming of files. When the team members finish updating the files in the child workspace, the updated files are copied to the parent workspace, replacing the old files with the new ones (“putback”).

The work of editing files is done in the child workspace, keeping the master copies safe and unchanged in the parent workspace. Before a file can be edited, it must be checked out by the user (a team member). That is, a writeable copy of the file is created. After editing the file, the update is saved and the file is checked in again. Although multiple users can work within a single child workspace, only one user at a time may check out any given file for editing.

A parent workspace may have multiple child workspaces, providing concurrent and parallel development of the software. Thus, there may be multiple versions of the same file over different child workspaces. When a user tries to put back files from a child workspace, the parent workspace first checks to see if an updated version of the files has already been put back from another child workspace. If not, the parent workspace accepts the putback and updates its version of the files. However, if the same files have already been put back, a bringover update that contains the latest versions of the files is sent to the child workspace. The user must then resolve the differences before the putback of the merged file versions can take place. The merged files may be recompiled and tested before the putback.

When a user needs access to files in another user's child workspace, from within a single child workspace, only one user at a time may check out a file for editing (known as “access control”). That is, a file that has been checked out by one user may not be checked out by another until the first person checks it in. In addition, one or more specific data versions of a workspace may be saved as a “freezepoint file” so that the exact state of the workspace can be re-created at some later time. The freezepoint file may be a list of deltas (differences) of file versions, and not a full copy of the workspace in order to make freezepoint files compact. For example, a freezepoint file may be created at every bringover and putback.

In a typical team development environment, some of the team members may be local users, but others may be located at a different site or working from home and may want to use the version control system remotely. For example, a user (client) may want to bring over a child workspace from the parent workplace which resides on a remote machine (server), or a remote user may want to check out a file from the child workspace. However, proprietary client/server protocols or standard network file sharing protocols, such as Network File Systems (NFS) (also known as a distributed file system) on the UNIX®-type operating systems (available from a number of vendors and open source providers) or Server Message Block (SMB) on the Windows® operating systems (a series of operating systems available from Microsoft Corporation of Redmond, Wash.), typically require a local area network (LAN) or wide area network (WAN) to use the client/server scheme. Such protocols also depend on an operating system running on the machine and require that the server side and the client side have an implementation of the same file sharing protocol. Since there are numerous operating systems presently available on the market, it may not always be possible to install specific protocols for a specific operating system running on a server machine or a client machine.

On the other hand, some version control systems with remote capabilities employing client/server protocols and application programming interface (API), for example, servlet based version control servers, such as TeamWare remote transaction, requires only standard TCP/IP connections which are more convenient. A server platform on which such a version control system is to be installed includes specific hosting server software running on a specific operating system. For example, hosting server software may be a web server such as Tomcat, available from the Apache Software Foundation of Forest Hill, Md., or an application server such as a reference implementation for Java 2 platform, Enterprise Edition (J2EE™) or iPlanet™ Application Server (including iPlanet™ Web Server), both available from Sun Microsystems, Inc. of Palo Alto, Calif. A deployment to each web server or application server is a unique process that requires a special installer. A separate installer is also required for each operating system, such as UNIX®, Linux, Solaris™, or Windows® NT. However, creating an installer for a specific server on a specific operating system is a time consuming process, and maintaining an installer also requires continuous updating for new versions of the server and the operating system. Accordingly, it would be desirable to provide an automated installation process for a version control system server using standard deployment tools.

### BRIEF DESCRIPTION OF THE INVENTION

In a software development environment, a method for deploying version control system server software having a remote access capability, includes (a) providing a functional software unit implementing version control system server functionality, (b) providing a module deployment descriptor for directing a deployment tool to deploy the module, (c) packaging the functional software unit with the module deployment descriptor into a Web module for deployment in accordance with a component-based platform-independent specification, and (d) deploying the Web module onto a Web server platform using the deployment tool of the software development environment. The Web server platform includes a machine, an operation system, and hosting server software, and the deployment tool includes a server plug-in provided by a provider of the hosting server software. The server plug-in automatically installs a Web module on a corresponding server platform when the Web module complies with the component-based platform-independent specification. The version control system server software may also be packaged into an application-level software package complying with the component-based platform independent specification that can be deployed to an application server.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a block diagram schematically illustrating a deployment of the version control system server software packaged in a Web module in accordance with one embodiment of the present invention.

FIG. 2 is a block diagram schematically illustrating a Web module packaged and deployed onto a Web server as a server front end and a client remotely using the version control system, in accordance with one embodiment of the present invention.

FIG. 3 is a block diagram schematically illustrating a deployment to a selected server platform using a corresponding server plug-in of the deployment tools.

FIG. 4 is a block diagram schematically illustrating a deployment of the version control system server software packaged as application-level software in accordance with one embodiment of the present invention.

FIG. 5 is a process flow diagram schematically illustrating a method for providing a version control system having a remote access capability for a software development environment, in accordance with one embodiment of the present invention.

### DETAILED DESCRIPTION

Embodiments of the present invention are described herein in the context of a method for deploying version control system server software having a remote access capability. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with the present invention, the components, process steps, and/or data structures may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

A specialized application server program, such as a version control system server, can be designed to have a remote access capability. For example, the version control system server software may use a hyper text transfer type protocol, such as the Hyper Text Transfer Protocol (HTTP) or Hyper Text Transfer Protocol Secure (HTTPS) for remote client-server communications. Such a version control system server software is disclosed in U.S. patent application Ser. No. 09/899,473, filed on Jul. 5, 2001, in the names of inventors Anatoli Fomenko and Sadhana Rau and entitled “Teamware Server Working Over HTTP/HTTPS Connections” (assignee Docket No. P5822), commonly owned herewith, which is hereby incorporated herein by reference as if set forth fully herein.

In accordance with one embodiment of the present invention, the version control system server software with a remote access capability is implemented as an application or module complying with the component-based platform-independent specification, for example, Java 2 Platform, Enterprise Edition (J2EE™). Such a component-based platform-independent specification may employ a multi-tier, thin-client application model. The component-based platform independent specification, for example, the J2EE platform, includes a deployment specification and several sets of standards. The deployment specification is a standard that defines a common way of packaging applications for deployment on any platform compatible with the component-based platform independent specification. All platform products complying with the component-based platform independent specification support, for example, Java technology standards and Internet Engineering Task Force (IETF) standards including Hyper Text Markup Language (HTML), Hyper Text Transfer Protocol (HTTP), and Extensible Markup Language (XML). The component-based platform independent specification may base its middle-tier interoperability upon the well-known Common Object Request Broker Architecture (CORBA) standards.

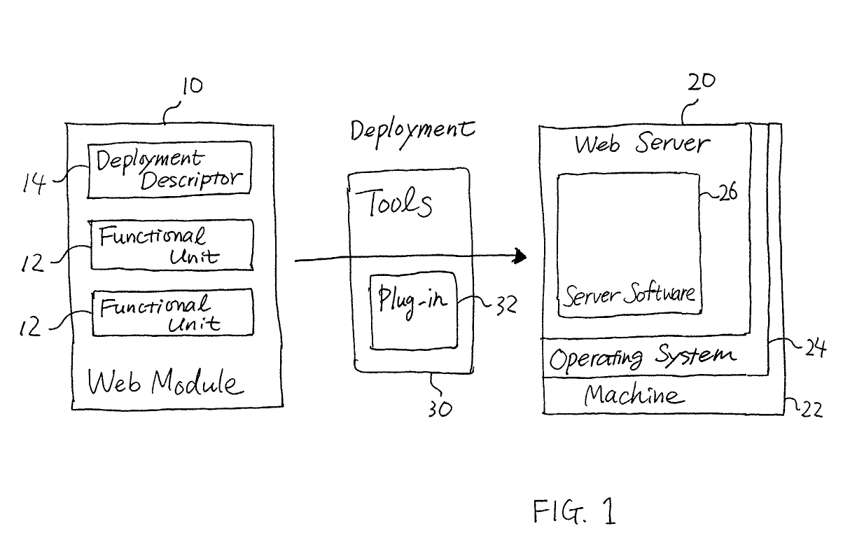

In accordance with one embodiment of the present invention, the version control system server software having a remote access capability is packaged for deployment as a Web module complying with the component-based platform-independent specification. Such a package is deployed automatically to a Web server using deployment tools that includes a server plug-in associated with the Web server. FIG. 1 schematically illustrates the deployment of the version control system server software packaged in a Web module 10. Such modules may be written in an object-oriented platform-independent programming language, such as Java™.

First, at least one functional software unit 12 implementing version control system server functionality is provided. For example, such functionality includes bring-over, put-back, check-out, check-in, creating freezepoint file, and the like, as described above. In addition, functional software units for authentication, security, and concurrency may be provided. The functional software unit 12 may include a program of instructions generating dynamic content and interacting with clients using a request-response scheme, or a program of instructions returning the dynamic content to the clients using template data, custom elements, scripting languages, and server-side objects. For example, the functional software unit 12 may be a servlet, which is a Java program generating dynamic content and interacting with web clients using a request-response paradigm, or JavaServer Pages™ (JSP™), which uses template data, custom elements, scripting languages and server-side Java objects to return content to a client or a web service (such a client may be a web browser). Typically the template data is HTML or XML elements.

Then, a module deployment descriptor 14 is provided so as to direct a deployment tool to deploy the module. A deployment descriptor is provided for each module (and application) and describes how the module (or application) should be deployed. For example, according to the J2EE specification (or J2EE platform), a deployment descriptor is an XML file, and directs a deployment tool to deploy a module or application with specific container options and also describes specific configuration requirement that a person deploying the module/application must resolve.

The functional software unit 12 and the module deployment descriptor 14 are packaged into a Web module 10 for deployment in accordance with a component-based platform-independent specification. A package is a collection of related classes and interfaces providing access protection and namespace management. For example, various classes and interfaces that complying with the component-based platform-independent specification may be bundled into packages by function. In order to create a package, for example, the module and the deployment descriptor are put in the appropriate directories, and the application directory hierarchy is packaged in a file using a file format specified by the component-based platform independent specification.

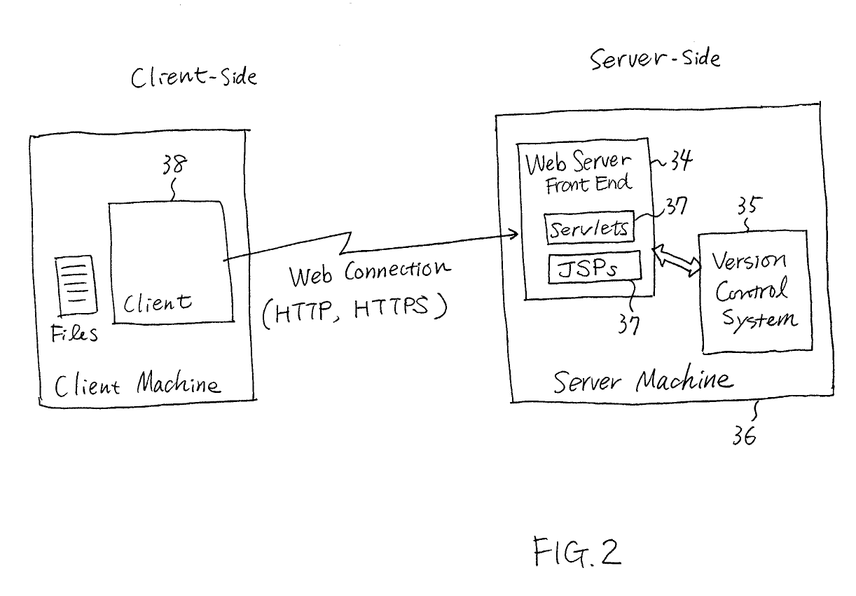

It should be noted that the entire version control system server application is not necessarily packaged into a Web module or a set of modules complying with the component-based platform-independent specification. According to this embodiment, as shown in FIG. 2, the packaged and deployed portion functions as a Web server front end 34, and the remaining portion, i.e., the “standard” version control system application 35 itself is separately installed on the same (or different) server machine 36. The standard portion may or may not be written in a platform-independent programming language. Such a standard portion of the version control system application may be customized so as to work with a repository system. For example, such a version control system application is disclosed in U.S. patent application Ser. No. 09/900,763, filed on Jul. 5, 2001, in the names of inventors Anatoli Fomenko and Sadhana Rau and entitled “TeamWare Repository of TeamWare Workspaces” (assignee Docket No. P5908), commonly owned herewith, which is hereby incorporated herein by reference as if set forth fully herein. The deployed Web modules 37, such as servlets and JSPs, in the Web server front end 34 pass or propagate the version control system functionality (bringover, putback, etc.) requested by the client 38 to the standard portion, and vise versa.

Referring back to FIG. 1, the packaged Web module 10 is deployed onto a Web server platform 20 using a deployment tool 30 of the software development environment. The software development environment may be an integrated development environment with deployment capability, for example, Forte™ For Java, available from Sun Microsystems, JBuilder™ Enterprise, available from Borland Software, and the like. The deployment tools typically specify location-specific information, such as a list of local users that can access it and the name of the local database in the software development environment. The Web server platform 20 includes a machine 22, an operation system 24, and hosting server software 26. The deployment tools 30 includes a server plug-in 32 associated with the hosting server software 26. The server plug-in 32 automatically installs the Web module 10 on the hosting server software 26 running on the operation system 24 when it is called by the deployment tools 30.

A plug-in is an auxiliary program that works with a software package to enhance its capability. The server plug-in 32 is provided by a provider of the hosting server software 26 and is capable of installing a Web module complying with the component-based platform-independent specification. The hosting server software 26, which depends on the operating system, also supports the component-based platform-independent specification. The provider of the hosting server software 26 provides server plug-ins for the hosting server software for different operating systems, i.e., different server platforms. Thus, by packaging the version control system server as a Web module complying with the component-based platform-independent specification, the Web module can be automatically deployed on the hosting server software using the corresponding server plug-in. Since many such server plug-ins are available for a variety of hosting server software and operating systems, the user can chose a desirable deployment platform from among them.

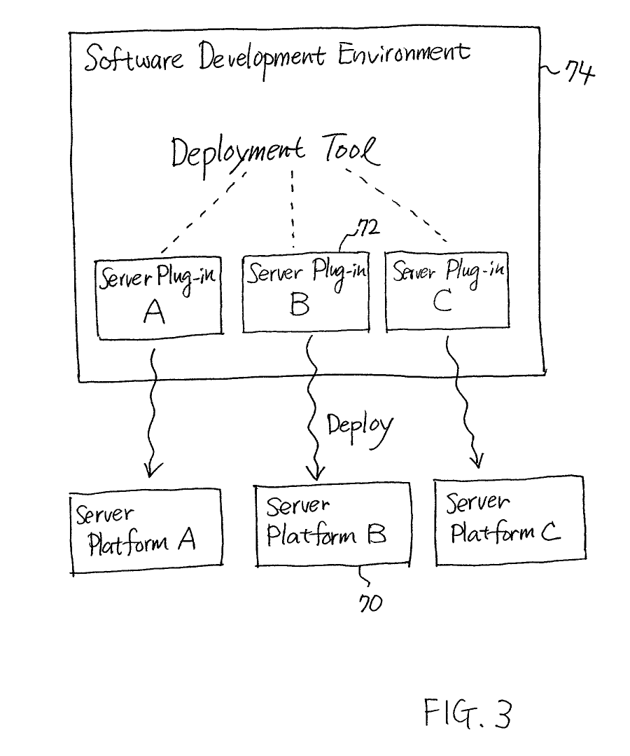

FIG. 3 schematically illustrates such deployment to a selected server platform 70 using the corresponding server plug-in 72. As shown in FIG. 3, the deployment tool of a software development environment 74 can call the corresponding server plug-in 72 for the selected server platform 70. In addition, since such server plug-ins are also updated in accordance with any update or revision of the hosting server software, it is easier for the user to deploy the version control system software even if the hosting server software has been updated.

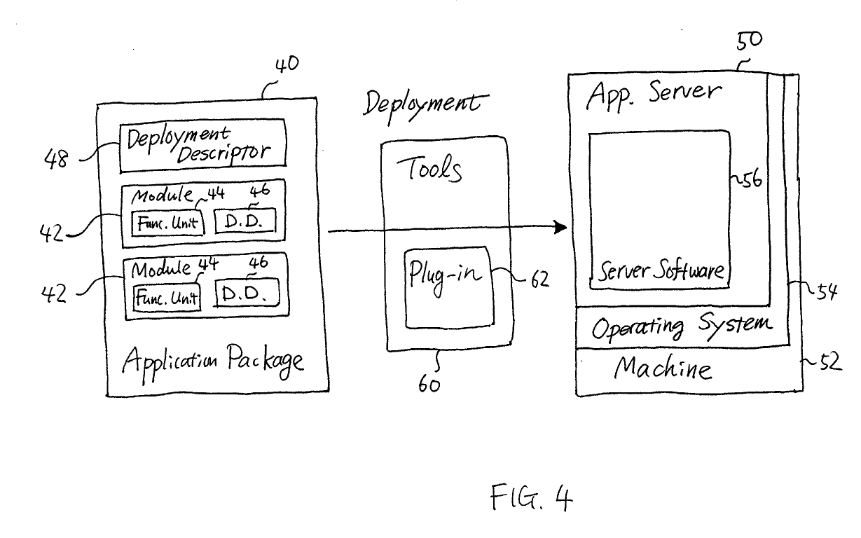

FIG. 4 schematically illustrates deployment of the version control system server software having a remote access capability packaged into an application-level software 40, in accordance with one embodiment of the present invention. The packaged application-level software 40 complies with the component-based platform-independent specification, and thus is deployed automatically to an application server using deployment tools that includes a server-plug in associated with the application server. The application-level software may be written in a platform-independent programming language, such as Java™.

First, at least one module 42 for the version control system server software is provided. Each module 42 includes at least one functional software unit 44 implementing version control system server functionality, and a module deployment descriptor 46 directing a deployment tool to deploy the module 42. Similarly to the previous embodiment, the version control server system functionality includes bring-over, put-back, check-out, check-in, and the like. Functional software units for authentication, security, and concurrency may also be provided. The module deployment descriptor 46 describes how the module 42 should be deployed, as in the same manner as the previous embodiment.

The functional software unit 44 may include a program of instructions for generating dynamic content and interacting with clients using a request-response scheme, or a program of instructions for returning the dynamic content to the clients using template data, custom elements, scripting languages, and server-side objects. The functional software unit 44 may also include a program of instructions capable of being called and executed remotely using servlet mechanism or web services. The calling programming sends a request and data to the remote program, which is executed, and results are passed back to the calling program. A module 42 may contain one or more functional software units 44, and the package 40 may contain one or more modules 42.

In accordance with one embodiment of the present invention, the functional software units 44 are servlets and JavaServer Pages™ (JSP™ ), optionally include Enterprise JavaBeans™ (EJB). A servlet is a Java program generating dynamic content and interacting with web clients using a request-response paradigm. JavaServer Pages™ (JSP™) uses template data, custom elements, scripting languages and server-side Java objects to return content to a client. Typically, the template data is HTML or XML elements. Enterprise JavaBeans are independent Java program modules for the development and deployment of object-oriented and distributed applications, and can be called up and executed remotely. That is, Enterprise JavaBeans components can be run on a server remotely in a distributed computing environment using Remote Method Invocation (RMI), available from Sun Microsystems, Inc. of Palo Alto, Calif., or appropriate CORBA-compliant software, available from a number of vendors. Employing Enterprise JavaBeans, the entire version control system server application can be packaged for deployment as a J2EE application.

The module(s) 42 are packaged with an application deployment descriptor 48 into the application-level software 40 for deployment in accordance with a component-based platform-independent specification. Similarly to the previous embodiment, the module(s) and the deployment descriptor are put in the appropriate directories, and the application directory hierarchy is packaged in a file using a file format specified by the component-based platform independent specification. The application deployment descriptor 48 directs the deployment tool to deploy the application-level software.

The packaged application-level software 40 is deployed onto a server platform 50 using deployment tools 60 of the software development environment. The server platform 50 includes a machine 52, operating system 54, and hosting application server software 56. The deployment tools 60 includes a server plug-in 62 associated with the hosting server software 56. The server plug-in 62 is provided by the provider of the hosting server software 56, and automatically installs the packaged application-level software 40 onto the hosting application server software 56 running on the operation system 54, if the application-level software complies with the component-based platform-independent specification.

The hosting server software 56 also supports the component-based platform-independent specification, but still depends on the operating system 54. However, the provider of the hosting server software 56 typically provides the server plug-ins for the hosting server software for different operating systems. Thus, by packaging the version control system server as an application-level software package complying with the component-based platform-independent specification, the application-level software can be automatically deployed on the hosting application server software using the corresponding server plug-in. Since many such server plug-ins are available for a variety of hosting server software packages and operating systems, the user can chose a desirable deployment platform from among them. The deployment tool can call a corresponding server plug-in for the selected server platform. In addition, since such server plug-ins are also updated in accordance with any update or revision of the hosting server software, it is easier for the user to deploy the version control system software even if the hosting server software has been updated.

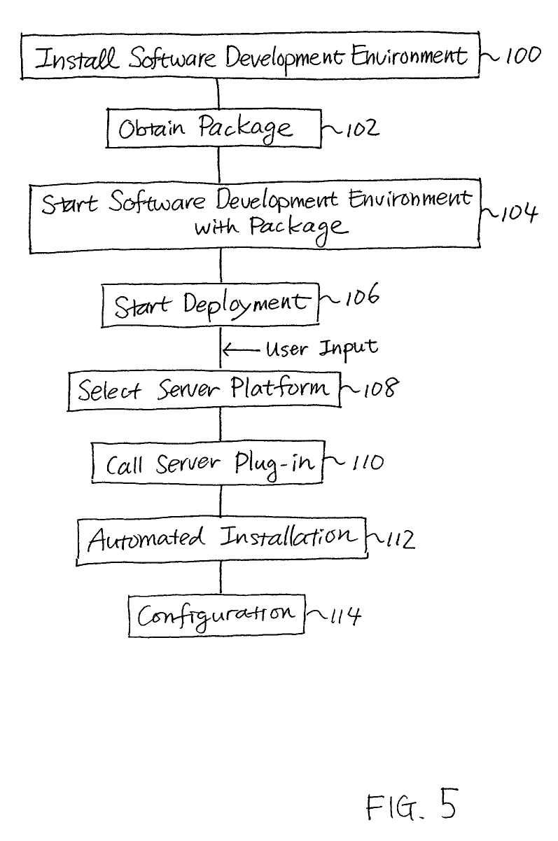

FIG. 5 schematically illustrates a method for providing a version control system having a remote access capability for a software development environment, in accordance with one embodiment of the present invention. The software development environment includes a client tier and a server tier. Such a software development environment may be an integrated development environment with deployment capability, for example, Forte™ For Java, available from Sun Microsystems, Inc. of Palo Alto, California, JBuilder™ Enterprise, available from Borland Software Corporation of Scotts Valley, Calif., and the like.

First, the software development environment software is installed on the server side (100). The software program development environment has deployment tools including a server plug-in for a server platform. The server plug-in is provided by a provider of the server software for a corresponding server platform. The server platform complies with a component-based platform independent specification, for example, Java 2 Platform, Enterprise Edition (J2EETM). Typically, the deployment tools have several server plug-ins for different server platforms. The “standard” portion of the version control system server (file system) is also installed on the server, and the corresponding program to remotely use the version control system is installed on the client side. If hosting server software (such as a Web server or an application server) has not been installed, it is also installed on the server machine.

Version control system server software is packaged for deployment as a Web module or application-level software (e.g., a J2EE application) in accordance with the component-based platform-independent specification, and obtained for the. software development environment (102). The packaged version control system server software includes at least one software module. The module includes at least one functional software unit implementing version control system server functionality, and a module deployment descriptor for directing a deployment tool to deploy the module, similarly to the previous examples.

The software development environment is started with the packaged version control system server software (104). That is, the file system of the version control system is mounted with the software development environment so as to be available for access locally. The deployment process is started (106), and, in response to a user's input, a server platform having a corresponding server plug-in is selected (108). The deployment tools may display a list of server platforms to the user via a graphic user interface (GUI). The packaged version control system server software is deployed onto the selected server platform using the deployment tools. That is, the deployment tools call a server plug-in corresponding to the selected server platform (110), and the server plug-in automatically installing the packaged version control server software onto the selected server platform (112).

When the version control system server software is packaged as a Web module, the package is deployed on a Web server platform. If the version control system server software is packaged as application-level software with an application deployment descriptor (for example, a J2EE application), the package is deployed on an application server platform.

After deployment, the version control system software is ready to run, and can be started. If required, the version control system server software may be configured by the deployer or user (114). The customization of the installation may be done in two ways, for example, with standard configuration files such as web.xml, and with a special servlet (AdminServlet, or a specialized installation servlet, or JSP) that will detect if the installation was not completed. After that, the version control system software is started at the client side, and the client can access the version control system server using a remote communication protocol.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

What is claimed is:

1. In a software development environment, a method for deploying version control system server software having a remote access capability, said method comprising:
providing a functional software unit implementing version control system server functionality;
providing a module deployment descriptor for directing a deployment tool to deploy the module;
packaging the functional software unit with the module deployment descriptor into a Web module for deployment in accordance with a component-based platform-independent specification; and
deploying the Web module onto a Web server platform using the deployment tool of the software development environment, the Web server platform including a machine, an operation system, and hosting server software, the deployment tool including a server plug-in provided by a provider of the hosting server software, the server plug-in automatically installing a Web module on a corresponding server platform when the Web module complies with the component-based platform-independent specification.

2. A method according to claim 1 wherein the functional software unit includes a program of instructions for generating dynamic content and interacting with clients using a request-response scheme.

3. A method according to claim 1 wherein the functional software unit includes a program of instructions for returning the dynamic content to the clients using template data, custom elements, scripting languages, and server-side objects.

4. A method according to claim 1 wherein the remote access capability employs a hyper text transport type protocol.

5. A method according to claim 1 wherein said deploying comprises:
selecting, in response to a user's input, a server platform having a corresponding server plug-in; and
calling the corresponding server plug-in for the selected server platform.

6. A method according to claim 1 wherein the component-based platform-independent specification includes a component-based platform independent specification employing a multi-tier, thin-client application model.

7. A method according to claim 1 wherein the computer program development environment software includes an integrated development environment with deployment capability.

8. In a software development environment, a method for deploying version control system server software having a remote access capability, said method comprising:
providing a module for the version control system server software, the module comprising:
a functional software unit implementing version control system server functionality; and
a module deployment descriptor for directing a deployment tool to deploy the module;
packaging the module with an application deployment descriptor into application-level software for deployment in accordance with a component-based platform-independent specification, the application deployment descriptor directing the deployment tool to deploy the application-level software; and
deploying the application-level software onto a server platform using the deployment tool of the software development environment, the server platform including a machine, operating system, and hosting server software, the deployment tool including a server plug-in provided by a provider of the hosting server software, the server plug-in automatically installing application-level software on the corresponding server platform if the application-level software complies with the component-based platform-independent specification.

9. A method according to claim 8 wherein the functional software unit includes a program of instructions for generating dynamic content and interacting with clients using a request-response scheme.

10. A method according to claim 8 wherein the functional software unit includes a program of instructions for returning the dynamic content to the clients using template data, custom elements, scripting languages, and server-side objects.

11. A method according to claim 8 wherein the functional software unit includes a program of instructions capable of being called and executed remotely using servlet mechanism or web services.

12. A method according to claim 8 wherein the remote access capability employs a hyper text transport type of protocol.

13. A method according to claim 8 wherein said deploying comprises:
selecting, in response to a user's input, a server platform having a corresponding server plug-in; and
calling the corresponding server plug-in for the selected server platform.

14. A method according to claim 8 wherein the component-based platform-independent specification includes a component-based platform independent specification employing a multi-tier, thin-client application model.

15. A method according to claim 8 wherein the computer program development environment software includes an integrated development environment with deployment capability.

16. A method for providing a version control system having a remote access capability for a computer program development environment, the computer program development environment including a client tier and a server tier, said method comprising:
installing the computer program development environment software on a server, the computer program development environment software having a deployment tool including a server plug-in for a server platform, the server plug-in being provided by a provider of server software for the server platform, the server platform complying with a component-based platform independent specification;
packaging version control system server software for deployment in accordance with the component-based platform-independent specification, the packaged version control system server software including at least one module, the module comprising:
a functional software unit implementing version control system server functionality; and
a module deployment descriptor for directing the deployment tool to deploy the module;
starting the computer program development environment software with the packaged version control system server software;
selecting, in response to a user's input, a server platform having a corresponding server plug-in; and
deploying the packaged version control system server software onto the selected server platform using the deployment tool, the corresponding server plug-in automatically installing the packaged version control server software onto the selected server platform.

17. A method according to claim 16 wherein the server platform includes an operating system and hosting server software.

18. A method according to claim 16 wherein said packaging comprises:
packaging the version control system server software as a Web module for deployment on a Web server platform.

19. A method according to claim 18 wherein the functional software unit includes a program of instructions for generating dynamic content and interacting with clients using a request-response scheme.

20. A method according to claim 18 wherein the functional software unit includes a program of instructions for returning the dynamic content to the clients using template data, custom elements, scripting languages, and server-side objects.

21. A method according to claim 16 wherein said packaging comprises:
packaging the version control system server software as an application-level software with an application deployment descriptor for deployment on an application server platform, the application deployment descriptor directing a deployment tool to deploy the application-level software.

22. A method according to claim 21 wherein the functional software unit includes a program of instructions for generating dynamic content and interacting with clients using a request-response scheme.

23. A method according to claim 21 wherein the functional software unit includes a program of instructions for returning the dynamic content to the clients using template data, custom elements, scripting languages, and server-side objects.

24. A method according to claim 21 wherein the functional software unit includes a program of instructions capable of being called and executed remotely using a remote procedure call.

25. A method according to claim 16 wherein said deploying comprises:
selecting, in response to a user's input, a server platform having a corresponding server plug-in; and
calling the corresponding server plug-in for the selected server platform.

26. A method according to claim 16, further comprising:
starting the version control system software at the server; and
configuring the version control system server software deployed on the server platform, if required.

27. A method according to claim 26, further comprising:
starting the version control system software at the client; and
accessing from the client the version control system server.

28. A method according to claim 16 wherein the component-based platform-independent specification includes a component-based platform independent specification employing a multi-tier, thin-client application model.

29. A method according to claim 16 wherein the computer program development environment software includes an integrated development environment with deployment capability.

30. In a software development environment, an apparatus for deploying version control system server software having a remote access capability, said apparatus comprising:
means for providing a functional software unit implementing version control system server functionality;
means for providing a module deployment descriptor for directing a deployment tool to deploy the module;
means for packaging the functional software unit with the module deployment descriptor into a Web module for deployment in accordance with a component-based platform-independent specification; and
means for deploying the Web module onto a Web server platform using the deployment tool of the software development environment, the Web server platform including a machine, an operation system, and a hosting server software, the deployment tool including a server plug-in provided by a provider of the hosting server software, the server plug-in automatically installing a Web module on a corresponding server platform when the Web module complies with the component-based platform-independent specification.

31. An apparatus according to claim 30 wherein the functional software unit includes a program of instructions for generating dynamic content and interacting with clients using a request-response scheme.

32. An apparatus according to claim 30 wherein the functional software unit includes a program of instructions for returning the dynamic content to the clients using template data, custom elements, scripting languages, and server-side objects.

33. An apparatus according to claim 30 wherein the remote access capability employs a hyper text transport type protocol.

34. An apparatus according to claim 30 wherein said means for deploying comprises:
means for selecting, in response to a user's input, a server platform having a corresponding server plug-in; and
means for calling the corresponding server plug-in for the selected server platform.

35. An apparatus according to claim 30 wherein the component-based platform-independent specification includes a component-based platform independent specification employing a multi-tier, thin-client application model.

36. An apparatus according to claim 30 wherein the computer program development environment software includes an integrated development environment with deployment capability.

37. In a software development environment, an apparatus for deploying version control system server software having a remote access capability, said apparatus comprising:
means for providing a module for the version control system server software, the module comprising:
a functional software unit implementing version control system server functionality; and
a module deployment descriptor for directing a deployment tool to deploy the module;
means for packaging the module with an application deployment descriptor into application-level software for deployment in accordance with a component-based platform-independent specification, the application deployment descriptor directing the deployment tool to deploy the application-level software; and
means for deploying the application-level software onto a server platform using the deployment tool of the software development environment, the server platform including a machine, operating system, and hosting server software, the deployment tool including a server plug-in provided by a provider of the hosting server software, the server plug-in automatically installing application-level software on the corresponding server platform if the application-level software complies with the component-based platform-independent specification.

38. An apparatus according to claim 37 wherein the functional software unit includes a program of instructions for generating dynamic content and interacting with clients using a request-response scheme.

39. A method according to claim 37 wherein the functional software unit includes a program of instructions for returning the dynamic content to the clients using template data, custom elements, scripting languages, and server-side objects.

40. A method according to claim 37 wherein the functional software unit includes a program of instructions capable of being called and executed remotely using servlet mechanism or web services.

41. An apparatus according to claim 37 wherein the remote access capability employs a hyper text transport type of protocol.

42. An apparatus according to claim 37 wherein said means for deploying comprises:
means for selecting, in response to a user's input, a server platform having a corresponding server plug-in; and
means for calling the corresponding server plug-in for the selected server platform.

43. An apparatus according to claim 37 wherein the component-based platform-independent specification includes a component-based platform independent specification employing a multi-tier, thin-client application model.

44. An apparatus according to claim 37 wherein the computer program development environment software includes an integrated development environment with deployment capability.

45. An apparatus for providing a version control system having a remote access capability for a computer program development environment, the computer program development environment including a client tier and a server tier, said apparatus comprising:
means for installing the computer program development environment software on a server, the computer program development environment software having a deployment tool including a server plug-in for a server platform, the server plug-in being provided by a provider of server software for the server platform, the server platform complying with a component-based platform independent specification;
means for packaging version control system server software for deployment in accordance with the component-based platform-independent specification, the packaged version control system server software including at least one module, the module comprising:
a functional software unit implementing version control system server functionality; and
a module deployment descriptor for directing the deployment tool to deploy the module;
means for starting the computer program development environment software with the packaged version control system server software;
means for selecting, in response to a user's input, a server platform having a corresponding server plug-in; and
means for deploying the packaged version control system server software onto the selected server platform using the deployment tool, the corresponding server plug-in automatically installing the packaged version control server software onto the selected server platform.

46. An apparatus according to claim 45 wherein the server platform includes an operating system and hosting server software.

47. An apparatus according to claim 45 wherein said means for packaging comprises:
means for packaging the version control system server software as a Web module for deployment on a Web server platform.

48. An apparatus according to claim 47 wherein the functional software unit includes a program of instructions for generating dynamic content and interacting with clients using a request-response scheme.

49. An apparatus according to claim 47 wherein the functional software unit includes a program of instructions for returning the dynamic content to the clients using template data, custom elements, scripting languages, and server-side objects.

50. An apparatus according to claim 45 wherein said means for packaging comprises:
means for packaging the version control system server software as an application-level software with an application deployment descriptor for deployment to an application server platform, the application deployment descriptor directing the deployment tool to deploy the application-level software.

51. An apparatus according to claim 50 wherein the functional software unit includes a program of instructions for generating dynamic content and interacting with clients using a request-response scheme.

52. An apparatus according to claim 50 wherein the functional software unit includes a program of instructions for returning the dynamic content to the clients using template data, custom elements, scripting languages, and server-side objects.

53. An apparatus according to claim 50 wherein the functional software unit includes a program of instructions capable of being called and executed remotely using servlet mechanism or web services.

54. An apparatus according to claim 45 wherein said means for deploying comprises:
means for selecting, in response to a user's input, a server platform having a corresponding server plug-in; and
means for calling the corresponding server plug-in for the selected server platform.

55. An apparatus method according to claim 45, further comprising:
means for starting the version control system software at the server; and
means for configuring the version control system server software deployed to the server platform, if required.

56. An apparatus according to claim 55, further comprising:
means for starting the version control system software at the client; and
means for accessing from the client the version control system server.

57. An apparatus according to claim 45 wherein the component-based platform-independent specification includes a component-based platform independent specification employing a multi-tier, thin-client application model.

58. An apparatus according to claim 45 wherein the computer program development environment software includes an integrated development environment with deployment capability.

59. A program storage device readable by a machine, tangibly embodying a program of instructions executable by the machine to perform, in a software development environment, a method for deploying version control system server software having a remote access capability, said method comprising:
providing a functional software unit implementing version control system server functionality;
providing a module deployment descriptor for directing a deployment tool to deploy the module;
packaging the functional software unit with the module deployment descriptor into a Web module for deployment in accordance with a component-based platform-independent specification; and
deploying the Web module onto a Web server platform using the deployment tool of the software development environment, the Web server platform including a machine, an operation system, and a hosting server software, the deployment tool including a server plug-in provided by a provider of the hosting server software, the server plug-in automatically installing a Web module on a corresponding server platform when the Web module complies with the component-based platform-independent specification.

60. A program storage device readable by a machine, tangibly embodying a program of instructions executable by the machine to perform, in a software development environment, a method for deploying version control system server software having a remote access capability, said method comprising:
providing a module for the version control system server software, the module comprising:
a functional software unit implementing version control system server functionality; and
a module deployment descriptor for directing a deployment tool to deploy the module;
packaging the module with an application deployment descriptor into application-level software for deployment in accordance with a component-based platform-independent specification, the application deployment descriptor directing the deployment tool to deploy the application-level software; and
deploying the application-level software onto a server platform using the deployment tool of the software development environment, the server platform including a machine, operating system, and hosting server software, the deployment tool including a server plug-in provided by a provider of the hosting server software, the server plug-in automatically installing application-level software on the corresponding server platform if the application-level software complies with the component-based platform-independent specification.

61. A program storage device readable by a machine, tangibly embodying a program of instructions executable by the machine to perform a method for providing a version control system having a remote access capability for a computer program development environment, the computer program development environment including a client tier and a server tier, said method comprising:
installing the computer program development environment software on a server, the computer program development environment software having a deployment tool including a server plug-in for a server platform, the server plug-in being provided by a provider of server software for the server platform, the server platform complying with a component-based platform independent specification;
packaging version control system server software for deployment in accordance with the component-based platform-independent specification, the packaged version control system server software including at least one module, the module comprising:
a functional software unit implementing version control system server functionality; and
a module deployment descriptor for directing the deployment tool to deploy the module;
starting the computer program development environment software with the packaged version control system server software; selecting, in response to a user's input, a server platform having a corresponding server plug-in; and
deploying the packaged version control system server software onto the selected server platform using the deployment tool, the corresponding server plug-in automatically installing the packaged version control server software onto the selected server platform.
